(19) United States
(12) Patent Application Publication
(10) Pub. No.: US 2026/0179461 A1
(43) Pub. Date: Jun. 25, 2026

(54) Systems, Devices, and Methods Utilizing Computer Vision for Guided Indicia Decoding

(71) Applicant: Zebra Technologies Corporation, Lincolnshire, IL (US)

(72) Inventors: Darran Michael Handshaw, Sound Beach, NY (US); John Britts, Port Jefferson Station, NY (US); Edward Barkan, Miller Place, NY (US); Andrew Joseph Zosel, Blaine, WA (US)

(73) Assignee: Zebra Technologies Corporation, Lincolnshire, IL (US)

(21) Appl. No.: 18/988,422

(22) Filed: Dec. 19, 2024

(51) Int. Cl. G07G 1/00; G06K 7/10

(52) U.S. Cl. CPC G07G 1/0045; G06K 7/10861; G06K 7/1096

(57) ABSTRACT

Systems, devices, and methods utilizing computer vision for guided indicia decoding are disclosed herein. The method detects, by a fixed data capture assembly having at least one field of view associated with an item scanning region, a first data capture region extending at least partially outside the item scanning region, and a second data capture region extending at least partially outside the item scanning region, whether an item is present within the item scanning region. Responsive to detecting the item is present within the item scanning region, the method projects, by a projector, an indicator within the item scanning region, and determines whether an indicia reader is utilized. Responsive to determining the indicia reader is not utilized, the method triggers a first modification of the indicator indicative of non-scanning of the item, and projects, by the projector, a first marker within the second data capture region corresponding to the first modification.

### BACKGROUND

A facility (e.g., a grocery store, convenience store, big box store, or the like) may deploy several point of sale (POS) terminals (e.g., checkout and/or self-checkout terminals) to expedite and improve an experience of a user (e.g., a customer and/or associate). A POS terminal may include a scanner (e.g., a single plane scanner, a multiplane scanner, a gateway scanner, or any suitable scanner) to scan and decode an identifier or indicium (e.g., a barcode) affixed to an item to identify the item and execute a transaction (e.g., a checkout or self-checkout process) for the item. However, conventional checkout and self-checkout POS terminals do not reliably and efficiently account for exceptions during a checkout or self-checkout process including, but not limited to, unfamiliarity of a user with a POS terminal (e.g., a first time user), an improper scanning event (e.g., an identifier or indicium that is not decoded), an omitted scanning event (e.g., an item proximate to a POS terminal that is not scanned), or the like. As such, conventional checkout and self-checkout POS terminals do not provide a sufficiently frictionless solution that expedites and improves an experience of a user by reducing and/or streamlining one or more checkout or self-checkout processing steps by automatically addressing exceptions during the checkout or self-checkout process.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an embodiment of the present disclosure.

FIG. 2 is a diagram illustrating an indicia reader of FIG. 1 in greater detail.

FIG. 3 is a diagram illustrating a fixed data capture assembly of FIG. 1 in greater detail.

FIG. 4 is a diagram illustrating components of the fixed data capture assembly of FIG. 3 in greater detail.

FIGS. 5A and 5B are diagrams illustrating another embodiment of the present disclosure.

FIG. 6 is a diagram illustrating another embodiment the present disclosure.

FIG. 7 is a flowchart illustrating processing steps carried out by an embodiment of the present disclosure.

FIGS. 8A-B, 9, and 10A-B are diagrams illustrating processing steps carried out by an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As mentioned above, conventional checkout and self-checkout POS terminals do not reliably and efficiently account for exceptions during a checkout or self-checkout process including, but not limited to, unfamiliarity of a user with a POS terminal (e.g., a first time user), an improper scanning event (e.g., an identifier or indicium that is not decoded), an omitted scanning event (e.g., an item proximate to a POS terminal that is not scanned), or the like. For example, at a POS, a user generally relies on a position of one or more windows of a scanner (e.g., a bioptic scanner or a slot scanner) as a guide to aim or swipe an item to scan and decode an identifier or indicium (e.g., a barcode) thereof but this is often misleading because the fields of view (FsOV) originating from the one or more windows of the scanner do not completely fill the one or more windows and thus the scanner will not decode the barcode. This can frustrate a user because the scanner will not decode the barcode despite the item being proximate to the one or more windows of the scanner which often results in a timeout or error that requires intervention (e.g., assistance from an associate or manager). Thus, these exceptions delay the checkout or self-checkout process and frustrate the experience of a user. As such, conventional checkout and self-checkout POS terminals do not provide a sufficiently frictionless solution that expedites and improves an experience of a user by reducing and/or streamlining one or more checkout or self-checkout processing steps by automatically addressing exceptions during the checkout or self-checkout process.

Thus, conventional checkout and self-checkout POS terminals suffer from a general lack of versatility because conventional checkout and self-checkout POS terminals cannot automatically and dynamically address exceptions during the checkout or self-checkout process. For example, these conventional checkout and self-checkout POS terminals cannot automatically and dynamically utilize computer vision for guided indicia decoding via projected indicators and/or markers at a POS terminal to assist a user during a checkout or self-checkout process and expedite and improve an experience of a user.

Overall, this lack of versatility causes conventional checkout and self-checkout POS terminals to provide underwhelming performance and reduce the accuracy, efficiency, and general timeliness of scanning and decoding an identifier or indicium of an item to identify the item (e.g., to execute a transaction such as a checkout or self-checkout process for the item).

Thus, it is an objective of the present disclosure to eliminate these and other problems with conventional checkout and self-checkout POS terminals via systems, devices, and methods that can automatically and dynamically utilize computer vision for guided indicia decoding via projected indicators and/or markers at a POS terminal to assist a user during a checkout or self-checkout process and expedite and improve an experience of a user.

In an embodiment, the present disclosure is directed to a system. The system comprises a fixed data capture assembly, a projector, a processor, and a memory communicatively coupled to the processor. The fixed data capture assembly has at least one field of view (FOV) associated with one or more of an item scanning region of an indicia reader, a first data capture region extending at least partially outside the item scanning region, and a second data capture region extending at least partially outside the item scanning region. The projector is configured to project light within the item scanning region and at least one of the first data capture region and the second data capture region. The memory stores instructions that, when executed by the processor, cause the system to: determine whether an item is present within the item scanning region during a first time period; responsive to determining the item is present within the item scanning region during the first time period; project, by the projector, an indicator within the item scanning region where the indicator is indicative of the first time period, and determine whether the indicia reader is utilized; and responsive to determining the indicia reader is not utilized, trigger a first modification of the indicator where the first modification is indicative of non-scanning of the item, and project, by the projector, a first marker within the second data capture region corresponding to the first modification.

In an embodiment, the present disclosure is directed to a device. The device may be a fixed data capture assembly. The fixed data capture assembly comprises at least one field of view (FOV); a projector; a processor; and a memory communicatively coupled to the processor. The at least one field of view (FOV) is associated with one or more of an item scanning region of an indicia reader, a first data capture region extending at least partially outside the item scanning region, and a second data capture region extending at least partially outside the item scanning region. The projector is configured to project light within the item scanning region and at least one of the first data capture region and the second data capture region. The memory stores instructions that, when executed by the processor, cause the fixed data capture assembly to: determine whether an item is present within the item scanning region during a first time period; responsive to determining the item is present within the item scanning region during the first time period; project, by the projector, an indicator within the item scanning region, the indicator being indicative of the first time period; determine whether the indicia reader is utilized; and responsive to determining the indicia reader is not utilized, trigger a first modification of the indicator, the first modification being indicative of non-scanning of the item, and project, by the projector, a first marker within the second data capture region corresponding to the first modification.

In an embodiment, the present disclosure is directed to a method. The method comprises: detecting, by a fixed data capture assembly having at least one field of view (FOV) associated with an item scanning region, a first data capture region extending at least partially outside the item scanning region, and a second data capture region extending at least partially outside the item scanning region, whether an item is present within the item scanning region during a first time period; responsive to detecting the item is present within the item scanning region during the first time period; projecting, by a projector, an indicator within the item scanning region, the indicator being indicative of the first time period, and determining whether an indicia reader is utilized; and responsive to determining the indicia reader is not utilized, triggering a first modification of the indicator, the first modification being indicative of non-scanning of the item, and projecting, by the projector, a first marker within the second data capture region corresponding to the first modification.

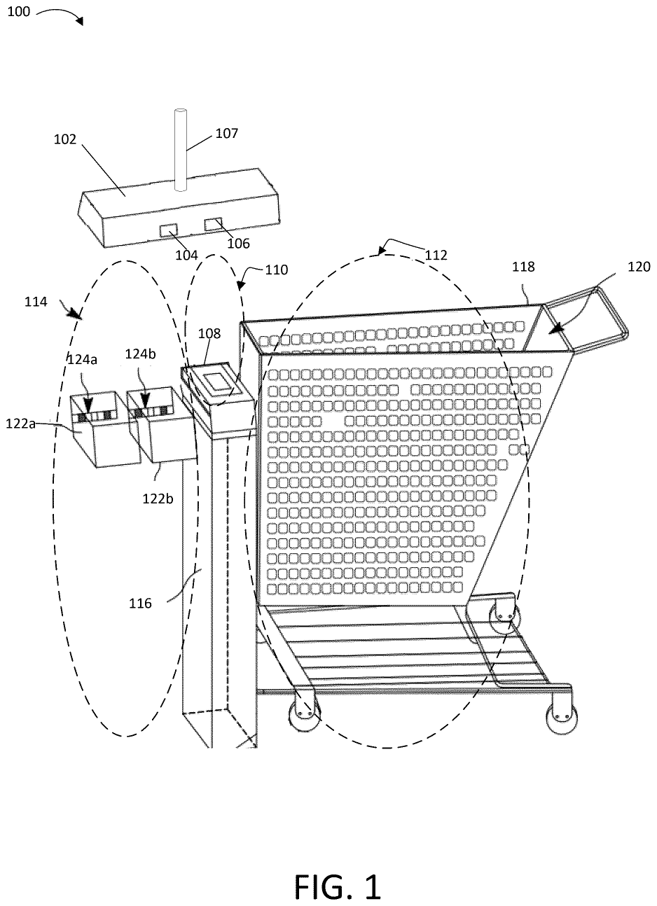

Turning to the Drawings, FIG. 1 is a diagram illustrating an embodiment of a system 100 of the present disclosure. The system 100 may be deployed in or as a POS terminal. The system comprises a fixed data capture assembly 102 having a projector 104 and an imaging assembly 106 and an indicia reader 108 (e.g., a scanner). The fixed data capture assembly 102 may be suspended from a ceiling or mounted to a ceiling above the indicia reader 108 and/or a POS terminal via a mechanism 107 (e.g., a pole, a bracket, or the like). In an embodiment, the fixed data capture assembly 102 may be attached to the indicia reader 108 and/or a POS terminal via a stalk, an extension arm, or any suitable mechanism. In an embodiment, the projector 104 and the imaging assembly 106 may be independent of one another. For example, the projector 104 may be suspended separately from the imaging assembly 106 from a ceiling or mounted to a ceiling above the indicia reader 108 and/or a POS terminal via a mechanism 107 (e.g., a pole, a bracket, or the like). In another example, the projector 104 may be attached separately from the imaging assembly 106 to the indicia reader 108 and/or a POS terminal via a stalk, an extension arm, or any suitable mechanism. Alternatively or additionally, in an embodiment, the projector 104 may be integrated with the indicia reader 108. For example, the projector 104 may be positioned below a horizontal scan surface of the indicia reader 108 and project an indicator upward where the indicator may be diffused by a surface or film attached to a window of the indicia reader 108.

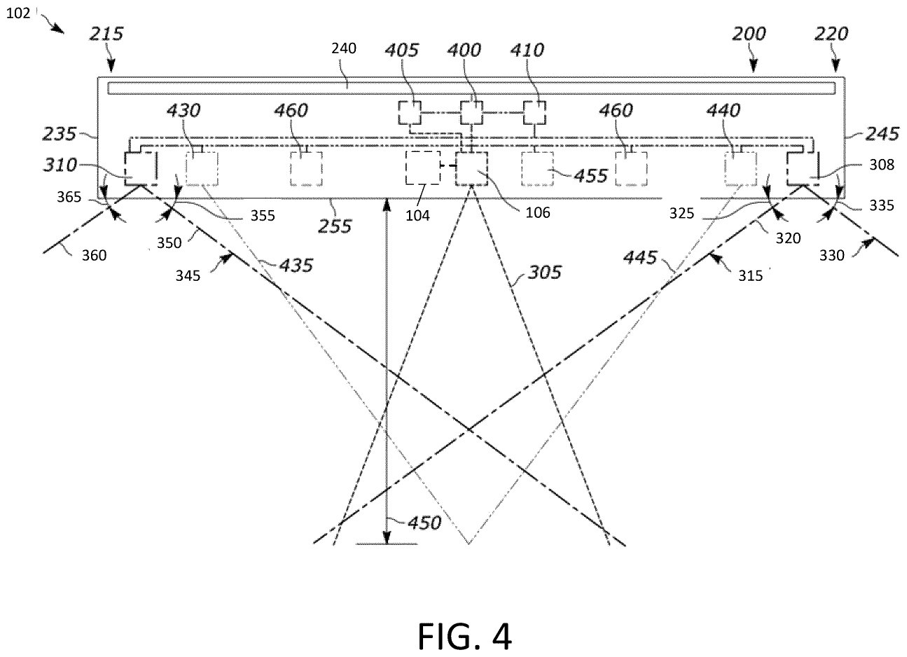

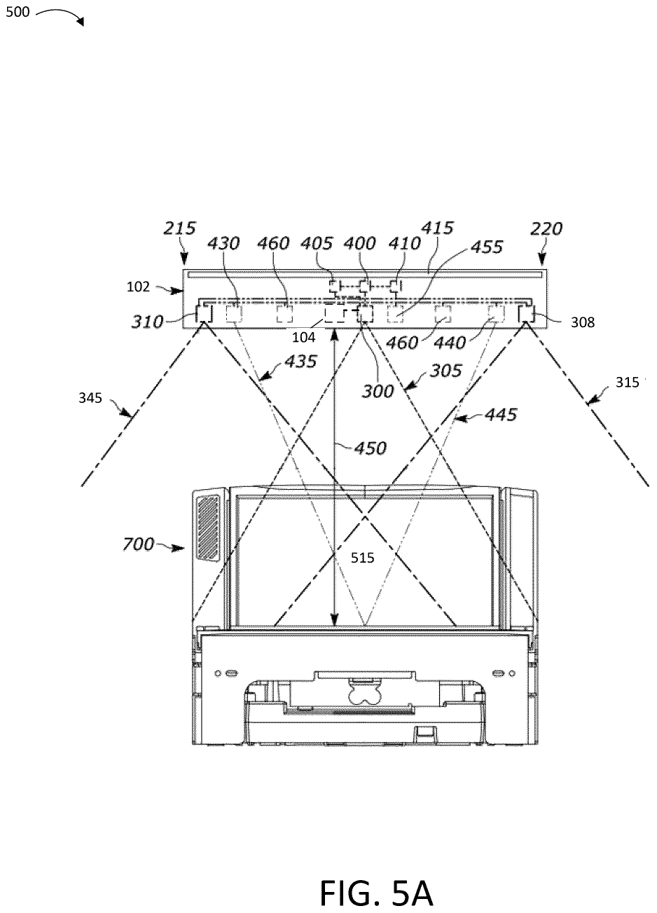

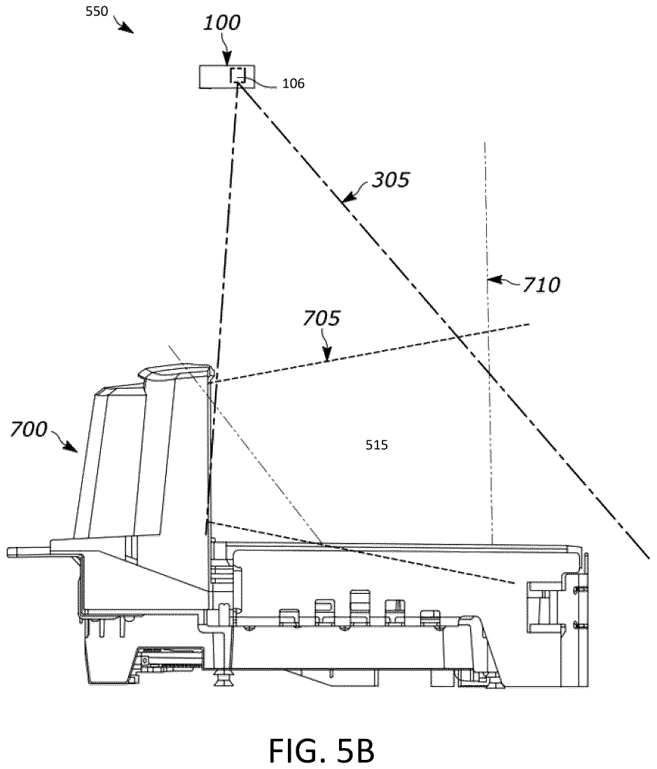

The fixed data capture assembly 102 may have at least one field of view (FOV) associated with one or more of an item scanning region 110 of an indicia reader, a first data capture region 112 extending at least partially outside the item scanning region 110, and a second data capture region 114 extending at least partially outside the item scanning region 110. The item scanning region 110 may correspond to one or more fields of view (FsOV) of the imaging assembly 106 and/or the indicia reader 108. For example, in an embodiment, a first FOV of the imaging assembly 106 may correspond to one of a downwardly directed looking vision camera assembly, an infrared (IR) sensor assembly, or a lidar sensor assembly comprising at least one imager configured to scan an indicium associated with an item within the item scanning region 110. Thus, in an embodiment, the system 100 may comprise the fixed data capture assembly 102 or the fixed data capture assembly 102 in conjunction with the indicia reader 108. Additionally, the imaging assembly 106 may have a second FOV corresponding to a downwardly directed looking vision camera assembly configured to detect an item within the first data capture region 112, and a third FOV corresponding to a downwardly directed looking vision camera assembly configured to detect an item within the second data capture region 114. As such, in an embodiment, the imaging assembly 106 may comprise one or more imagers (e.g., a wide-angle imager) respectively having the first, second and third FsOV. Alternatively, in another embodiment (as described below in relation to FIGS. 4 and 5A), the fixed data capture assembly 102 may include one or more imaging assemblies (e.g., imaging assembly 106, second imaging assembly 308, and third imaging assembly 310) comprising at least one imager corresponding to the first, second or third FsOV.

The projector 104 is configured to project light within the item scanning region 110 and at least one of the first data capture region 112 and the second data capture region 114. In an embodiment, the projector 104 is configured to project light within the item scanning region 110 and optionally one or more of the first data capture region 112 and the second data capture region 114. The projector 104 is communicatively coupled to the indicia reader 108 and/or an indicia reader of the imaging assembly 106. The projector 104 may be one of a laser projector, a light emitting diode (LED) projector, an array of fixed aiming patterns, a digital light processing (DLP) projector, or any suitable projector configured to project light within the item scanning region 110 and at least one of the first data capture region 112 and the second data capture region 114. As shown in FIG. 1, the projector 104 is positioned within the fixed data capture assembly 102. In an embodiment, the projector 104 may be independent of the fixed data capture assembly 102. For example, the projector 104 may be suspended from a ceiling, mounted to a ceiling, attached to the indicia reader 108 and/or a POS terminal via a stalk, an extension arm, or any suitable mechanism, or positioned within the indicia reader 108 and/or the POS terminal.

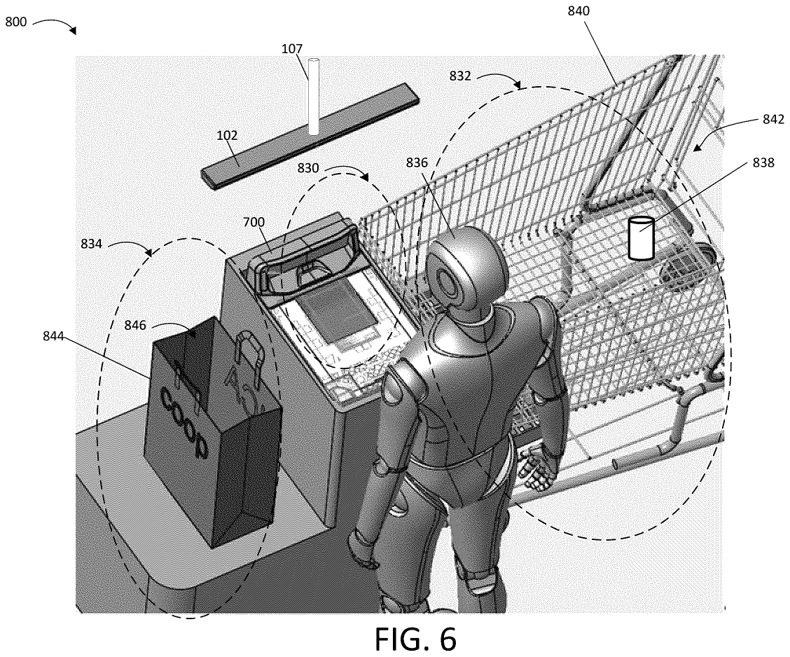

As described in further detail below in relation to FIGS. 6, 7, 8A-B, 9, and 10A-B, the projector 104 in conjunction with the imaging assembly 106 provide for guided indicia decoding via projected indicators and/or markers at a POS terminal to assist a user during a checkout or self-checkout process. For example, the projector 104 may project an indicator (e.g., a rectangular reticle, a circular reticle, a bounding box, an arrow, or the like) within the item scanning region 110, where the indicator is indicative of a first time period (e.g., a scanning session within the item scanning region 110 or a transaction session of the system 100) and of a positioning and/or a motion of an item within the item scanning region 110 to scan the item. In another example, the projector 104 may project a first marker within the second data capture region 114 indicative of non-scanning of an item, where the first marker is at least one of a shape or text indicating to a user not to position the item within the second data capture region 114. In another example, the projector 104 may project a second marker within the first data capture region 112 indicative of an item being present within the first data capture region 112 and outside of the item scanning region 110 during the first time period (e.g., a scanning session within the item scanning region 110 or a transaction session of the system 100), where the second marker is at least one of a shape or text indicating to a user to position the item within the item scanning region 110 or a path from the first data capture region 112 to the item scanning region 110 for positioning the item in the item scanning region 110. In yet another example, the projector 104 may project a third marker within the second data capture region 114 indicative of scanning of an item, where the third marker is at least one of a shape or text indicating to a user to position the item within the second data capture region 114 or a path from the item scanning region 110 to the second data capture region 114 for positioning the item in the second data capture region 114.

The indicia reader 108 may be a scanner. For example, the indicia reader 108 may be, but is not limited to, a single plane scanner, a multiplane scanner, a gateway scanner, or any suitable scanner to scan and decode an identifier or indicium (e.g., a barcode) affixed to an item within the item scanning region 110 to identify the item and effect a transaction (e.g., a checkout or self-checkout process) for the item. The indicia reader 108 may be positioned within or on a POS terminal. For example, the indicia reader 108 may be positioned on a support structure 116 of a POS terminal between the first data capture region 112 and the second data capture region 114.

The first data capture region 112 is a lead-in area comprising one of a lead-in shopping cart area, a lead-in basket area, a lead-in flatbed cart area, a lead-in countertop area, or the like. As shown in FIG. 1, the first data capture region 112 includes a shopping cart 118 having an opening 120. As mentioned above, the imaging assembly 106 may have a second FOV corresponding to a downwardly directed looking vision camera assembly configured to detect an item within the first data capture region 112. The second FOV may include at least one of a partial or an entire opening of a shopping cart positioned in the lead-in shopping cart area and/or a partial or an entire bottom surface of the shopping cart positioned in the lead-in shopping cart area, a partial or an entire opening of a basket positioned in the lead-in basket area, a partial or an entire top surface of a flatbed cart positioned in the lead-in flatbed cart area, or a partial or an entire top surface of a countertop positioned in the lead-in countertop area.

The second data capture region 114 is a lead-out area comprising one of a lead-out shopping cart area, a lead-out basket area, a lead-out flatbed cart area, a lead-out countertop area, or the like. As shown in FIG. 1, the second data capture region 114 includes a first basket 122a having an opening 124a and a second basket 122b having an opening 124b. As mentioned above, the imaging assembly 106 may have a third FOV corresponding to a downwardly directed looking vision camera assembly configured to detect an item within the second data capture region 114. The third FOV may include at least one of a partial or an entire opening of a shopping cart positioned in the lead-out shopping cart area and/or a partial or an entire bottom surface of the shopping cart positioned in the lead-out shopping cart area, a partial or an entire opening of a basket positioned in the lead-out basket area, a partial or an entire top surface of a flatbed cart positioned in the lead-out flatbed cart area, or a partial or an entire top surface of a countertop positioned in the lead-out countertop area.

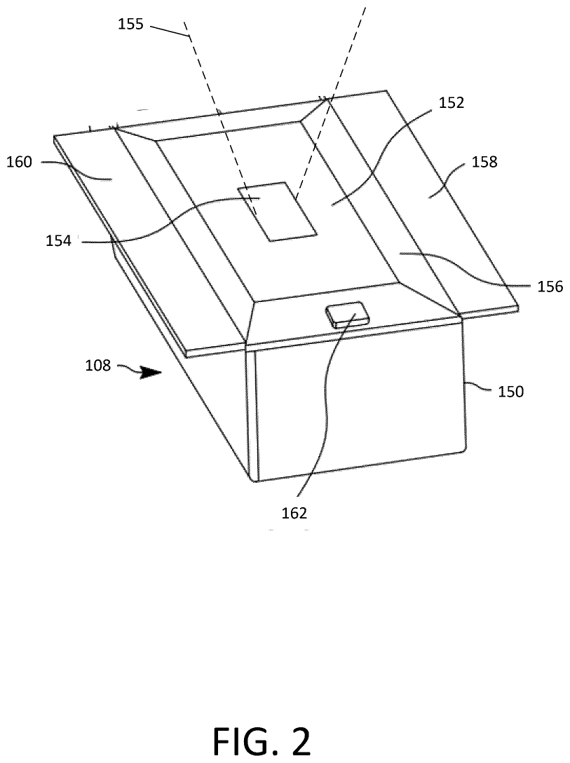

FIG. 2 is a diagram illustrating the indicia reader 108 of FIG. 1 in greater detail. As mentioned above, the indicia reader 108 may be a scanner (e.g., a single plane scanner, a multiplane scanner, a gateway scanner, or any suitable scanner) to scan and decode an identifier or indicium (e.g., a barcode) affixed to an item within the item scanning region 110 to identify the item and effect a transaction (e.g., a checkout or self-checkout process) for the item

The indicia reader 108 has a bottom frame 150 having an exit window 152 and at least one internally mounted upwardly directed imager 154 having an upward FOV 155. An internal mirror (not shown) within the frame 150 is positioned to form the FOV 155 as a split FOV formed of halves, where each half corresponds to a different portion of the imager array. This configuration allows for using a single upwardly directed imager with a wider field of view. A backward directed imager 162 is mounted in the frame 150 at a proximal end and may have a narrow FOV (not shown) directed toward a distal end of the frame 150 and overlapping with the FOV 155. The bottom frame 150 houses a weigh platter 156 positioned to measure the weight of an item resting on the exit window 152 or on a transparent, protective screen above the exit window 152. Additionally, the bottom frame 150 includes two adjustable platter wings 158 and 160 on opposite sides of the bottom frame 150 and extending the length thereof. The platter wings 158/160 may be adjustable between a deployed position and a fully folded position. In the deployed position, the platter wings 158/160 provide extended entrance and exit surfaces leading into the item scanning region 110 coinciding with the exit window 152 and the imaging assembly 106. In some examples, the exit window 152 is recessed below the height of the platter wings 158/160 when deployed. In some examples, the platter wings 158/160 may be angled upwardly and/or the platter wings 158/160 may have raised ridges on the outer edges so as to create a concave region for the weigh platter 156 so items do not roll off. In some examples, the outer edges of the bottom surface 150 may be flanged inwardly to create such a concave region.

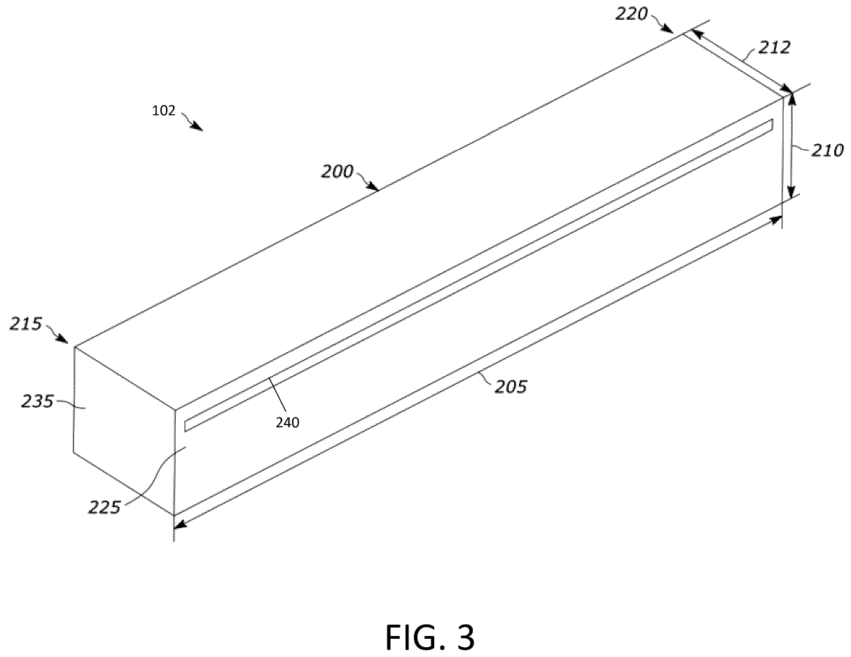

FIG. 3 is a diagram illustrating the fixed data capture assembly 102 of FIG. 1 in greater detail. The fixed data capture assembly 102 comprises a housing 200 that is configured to be positioned above an item scanning region 110. As mentioned above, the item scanning region 110 may correspond to one or more FsOV of the imaging assembly 106 and/or the indicia reader 108. For example, in an embodiment, a first FOV of the imaging assembly 106 may correspond to one of a downwardly directed looking vision camera assembly, an infrared (IR) sensor assembly, or a lidar sensor assembly comprising at least one imager configured to scan an indicium associated with an item within the item scanning region 110. Thus, in an embodiment, the system 100 may comprise the fixed data capture assembly 102 or the fixed data capture assembly 102 in conjunction with the indicia reader 108.

The housing 200 of fixed data capture assembly 102 has first end 215, a second end 220 opposite the first end 215, a first end surface 235, a second end surface (not shown), a front surface 225, and a back surface (not shown). A visual interface 240 is positioned on the front surface 225 of the housing 200. The visual user interface 240 can include one or more LEDs configured to provide various indications to a user including, but not limited to, a proper scanning event (e.g., an identifier or indicium that is decoded), an improper scanning event (e.g., an identifier or indicium that is not decoded), an omitted scanning event (e.g., an item proximate to a POS terminal that is not scanned), or the like.

Additionally, the housing 200 has a width 205, a height 210, and a depth 212. As used herein, the width 205 of the housing 200 is measured in a generally horizontal direction (e.g., in the direction that an item will be passed below the housing 200 for scanning), the height 210 of the housing 200 is measured in a generally vertical direction perpendicular to the width 205, and the depth 212 of the housing 200 is measured in a generally horizontal direction perpendicular to the direction of scanning, perpendicular to the width 205, and perpendicular to the height 210.

The housing 200 can be configured to suspend from, mount to, or otherwise attach to multiple support options. For example, the housing 200 may be suspended from a ceiling or mounted to a ceiling above the indicia reader 108 and/or a POS terminal via a mechanism 107 (e.g., a pole, a bracket, or the like). In another example, the housing 200 may be attached to the indicia reader 108 and/or a POS terminal via a stalk, an extension arm, or any suitable mechanism.

FIG. 4 is a diagram illustrating components of the fixed data capture assembly 102 of FIG. 3 in greater detail. As mentioned above, the fixed data capture assembly 102 may have at least one FOV associated with one or more of an item scanning region 110 of an indicia reader, a first data capture region 112 extending at least partially outside the item scanning region 110, and a second data capture region 114 extending at least partially outside the item scanning region 110. The item scanning region 110 may correspond to one or more FsOV of the imaging assembly 106 and/or the indicia reader 108. For example, in an embodiment, a first FOV 305 of the imaging assembly 106 may correspond to one of a downwardly directed looking vision camera assembly, an infrared (IR) sensor assembly, or a lidar sensor assembly comprising at least one imager configured to scan an indicium associated with an item within the item scanning region 110.

As shown in FIG. 4, the projector 104 is positioned within a housing 200 of the fixed data capture assembly 102 and is communicatively coupled to the imaging assembly 106. In an embodiment, the projector 104 may be independent of the fixed data capture assembly 102. For example, the projector 104 may be suspended from a ceiling, mounted to a ceiling, attached to the indicia reader 108 and/or a POS terminal via a stalk, an extension arm, or any suitable mechanism, or positioned within the indicia reader 108 and/or the POS terminal. The projector 104 is configured to project light within the item scanning region 110 and at least one of the first data capture region 112 and the second data capture region 114. The projector 104 may be one of a laser projector, an LED projector, an array of fixed aiming patterns, a DLP projector, or any suitable projector configured to project light within the item scanning region 110 and at least one of the first data capture region 112 and the second data capture region 114. As described in further detail below in relation to FIGS. 6, 7, 8A-B, 9, and 10A-B, the projector 104 in conjunction with the imaging assembly 106 provide for guided indicia decoding via projected indicators and/or markers at a POS terminal to assist a user during a checkout or self-checkout process.

The imaging assembly 106 may have one or more imagers (e.g., one or more vision cameras) having corresponding FsOV or the fixed data capture assembly 102 may include one or more additional imaging assemblies having corresponding FsOV. For example, the fixed data capture assembly 102 may include a second imaging assembly 308 having a second FOV 315 corresponding to a downwardly directed looking vision camera assembly configured to detect an item within the first data capture region 112. The second imaging assembly 308 may be positioned at least partially within the housing 200 proximate to the second end 220 of the housing 200, opposite the first end 215. The second imaging assembly 308 may have a second FOV 315 that is configured to at least partially overlap the first FOV 305 of the imaging assembly 106 and that is configured to extend at least partially outside of the item scanning area 110. For example, the second FOV 315 can extend into the first data capture region 112. The second FOV 315 may have a first inner lateral boundary 320 that forms a first angle 325 with a bottom surface 255 of the housing 200 and a first outer lateral boundary 330 that forms a second angle 335 with the bottom surface 255 of the housing 200. The first angle 325 may be greater than or equal to 25 degrees and less than or equal to 55 degrees and the second angle 335 may be greater than or equal to 10 degrees and less than or equal to 50 degrees.

In another example, the fixed data capture assembly 102 may also include a third imaging assembly 310 having a third FOV 345 corresponding to a downwardly directed looking vision camera assembly configured to detect an item within the second data capture region 114. The third imaging assembly 310 may be positions at least partially within the housing 200 proximate to the first end 215 of the housing 200, opposite the second end 220. The third imaging assembly 310 may have a third FOV 345 that is configured to at least partially overlap the first FOV 305 of the imaging assembly 106 and that is configured to extend at least partially outside of the item scanning region 110. For example, the third FOV 345 can extend into a second data capture region 114. The third FOV 345 may have a second inner lateral boundary 350 that forms a third angle 355 with the bottom surface 255 of the housing 200 and a second outer lateral boundary 360 that forms a fourth angle 365 with the bottom surface 255 of the housing 200. The third angle 355 may be greater than or equal to 25 degrees and less than or equal to 55 degrees and the fourth angle 365 can be greater than or equal to 10 degrees and less than or equal to 50 degrees.

As shown in FIG. 4, the second FOV 315 overlaps with the third FOV 345. The second FOV 315 and third FOV 345 overlap (e.g., the first inner lateral boundary 320 of the second FOV 315 and the second inner lateral boundary 350 of the third FOV 345 intersect) at a distance below the bottom surface 255 of the housing 200. Each of the second imaging assembly 308 and the third imaging assembly 310 may be configured to identify a predetermined illumination (e.g., a light of a certain color, brightness, duration, or the like) indicative of a decode of identifier or indicium of an item within the item scanning region 110, which can be used to verify that one or more items passed through the FsOV 315 and 345 have been properly scanned before being positioned in the second data capture region 114.

The fixed data capture assembly 102 may include any combination of an imaging assembly having a vision camera assembly, an infrared (IR) sensor assembly, or a lidar sensor assembly comprising at least one imager configured to scan an indicium associated with the item within the item scanning region 110 and an imaging assembly having a vision camera assembly configured to detect the item within the first data capture region 112 and/or the second data capture region 114.

The fixed data capture assembly 102 may include additional components. For example, the fixed data capture assembly 102 may include a controller 400, a decoder module 405, a processing module 410, a visual user interface 415, a first aimer 430, a second aimer 440, an illumination source 455, and an accessory 460.

The controller 400 is communicatively coupled to the imaging assembly 106, the second imaging assembly 308, and the third imaging assembly 310. The decoder module 405 is communicatively coupled to the imaging assembly 106 and the controller 400. In an embodiment, the decoder module 405 may also be communicatively coupled to the second imaging assembly 308 and/or the third imaging assembly 310 if the second imaging assembly 308 and/or the third imaging assembly 310 correspond to one of a downwardly directed looking vision camera assembly, an infrared (IR) sensor assembly, or a lidar sensor assembly comprising at least one imager configured to scan (e.g., read and decode) an indicium associated with an item within the item scanning region 110.

The video processing module 410 is communicatively coupled to second imaging assembly 308 and/or the third imaging assembly 310. The visual interface 240 is communicatively coupled to the controller 400. The visual user interface 240 can include one or more LEDs and the controller 400 can be configured to illuminate the LEDs (e.g., via different colors, intensities, patterns, or the like) to provide various indications to a user including, but not limited to, a proper scanning event (e.g., an identifier or indicium that is decoded), an improper scanning event (e.g., an identifier or indicium that is not decoded), an omitted scanning event (e.g., an item proximate to a POS terminal that is not scanned), or the like.

The first aimer 430 is configured to generate a first light beam 435 and the second aimer 440 is configured to generate a second light beam 445, which can be utilized during installation of the fixed data capture assembly 102 to position the fixed data capture assembly 102 at a desired distance above a surface of an indicia reader 108 and/or a POS terminal. For example, the first aimer 430 and the second aimer 440 may be positioned such that the first light beam 435 and the second light beam 445 intersect at a predetermined distance 450 (e.g., a desired distance above a surface of an indicia reader 108 and/or a POS terminal) below the bottom surface 255 of the housing 200 of the fixed data capture assembly 102.

The illumination source 455 is communicatively coupled to controller 400. The illumination source 455 is configured to illuminate the item scanning region 110 to provide sufficient light to scan (e.g., read and decode) an indicium associated with an item within the item scanning region 110. The accessory 460 is communicatively coupled to controller 400. The accessory 460 may be, but is not limited to, one or more of a three-dimensional (3D) sensor, an infra-red (IR) wakeup system, a radio-frequency identification (RFID) antenna, a radar, a radio frequency (RF) detector, an electronic article surveillance (EAS) system, or the like.

In an embodiment, the fixed data capture assembly 102 may include an audio detector (not shown) positioned at least partially within the housing 200 and configured to identify a predetermined audio signal. For example, the audio detector may identify a sound of a certain tone, decibel level, and/or duration, to provide various indications to a user including, but not limited to, a proper scanning event (e.g., an identifier or indicium that is decoded), an improper scanning event (e.g., an identifier or indicium that is not decoded), an omitted scanning event (e.g., an item proximate to a POS terminal that is not scanned), or the like.

FIGS. 5A and 5B are diagrams illustrating another embodiment of the present disclosure. As mentioned above, the indicia reader 108 may be a scanner (e.g., a single plane scanner, a multiplane scanner, a gateway scanner, or any suitable scanner) to scan and decode an identifier or indicium (e.g., a barcode) affixed to an item within the item scanning region 110 to identify the item and execute a transaction (e.g., a checkout or self-checkout process) for the item. FIG. 5A is a diagram 500 illustrating a front view of the fixed capture data assembly 102 operable in conjunction with a bioptic indicia reader 700 and FIG. 5B is a diagram 550 illustrating a side view of the fixed capture data assembly 102 operable in conjunction with the bioptic indicia reader 700.

As shown in FIGS. 5A and 5B, the item scanning region 515 can include a region where a first bioptic FOV 705 originating from a generally upright window in an upper housing portion of the bioptic indicia reader 700 intersects a second bioptic FOV 710 originating from a generally horizontal window in a platter of the bioptic indicia reader 700. In other embodiments, other item scanning regions are possible based on a type of indicia reader.

FIG. 6 is a diagram 800 illustrating another embodiment of a system of the present disclosure. For legibility of FIG. 6, the components of the fixed data capture assembly 102 and the indicia reader 700, and the respective features thereof (e.g., FsOV), as described above, and illustrated and labeled in relation to FIGS. 1, 3, 4, and 5A-B, are not illustrated and labeled individually.

The system may be deployed in or as a POS terminal. The system comprises a fixed data capture assembly 102 having a projector 104 (as shown in FIGS. 1, 4, and 5A) and an imaging assembly 106 (as shown in FIGS. 1, 4, and 5A-B) and an indicia reader 700 (e.g., a bioptic scanner as shown in FIGS. 5A-B). The fixed data capture assembly 102 may be suspended from a ceiling or mounted to a ceiling above the indicia reader 700 and/or a POS terminal via a mechanism 107 (e.g., a pole, a bracket, or the like). In an embodiment, the fixed data capture assembly 102 may be attached to the indicia reader 700 and/or a POS terminal via a stalk, an extension arm, or any suitable mechanism.

The fixed data capture assembly 102 may have at least one FOV associated with one or more of an item scanning region 830 of an indicia reader, a first data capture region 832 extending at least partially outside the item scanning region 830, and a second data capture region 834 extending at least partially outside the item scanning region 830. The item scanning region 830 may correspond to one or more FsOV of the imaging assembly 106 and/or the indicia reader 700. For example, in an embodiment, a first FOV (not shown) of the imaging assembly 106 may correspond to one of a downwardly directed looking vision camera assembly, an infrared (IR) sensor assembly, or a lidar sensor assembly comprising at least one imager configured to scan an indicium associated with an item 838 within the item scanning region 830. Thus, in an embodiment, the system 100 may comprise the fixed data capture assembly 102 or the fixed data capture assembly 102 in conjunction with the indicia reader 700. Additionally, the imaging assembly 106 may have a second FOV (not shown) corresponding to a downwardly directed looking vision camera assembly configured to detect an item 838 within the first data capture region 832, and a third FOV (not shown) corresponding to a downwardly directed looking vision camera assembly configured to detect an item 838 within the second data capture region 834. As such, in an embodiment, the imaging assembly 106 may comprise one or more imagers (e.g., a wide-angle imager) respectively having the first, second and third FsOV. Alternatively, in another embodiment (as described above in relation to FIGS. 4 and 5A), the fixed data capture assembly 102 may include one or more imaging assemblies (e.g., imaging assembly 106, second imaging assembly 308, and third imaging assembly 310) comprising at least one imager corresponding to the first, second or third FsOV.

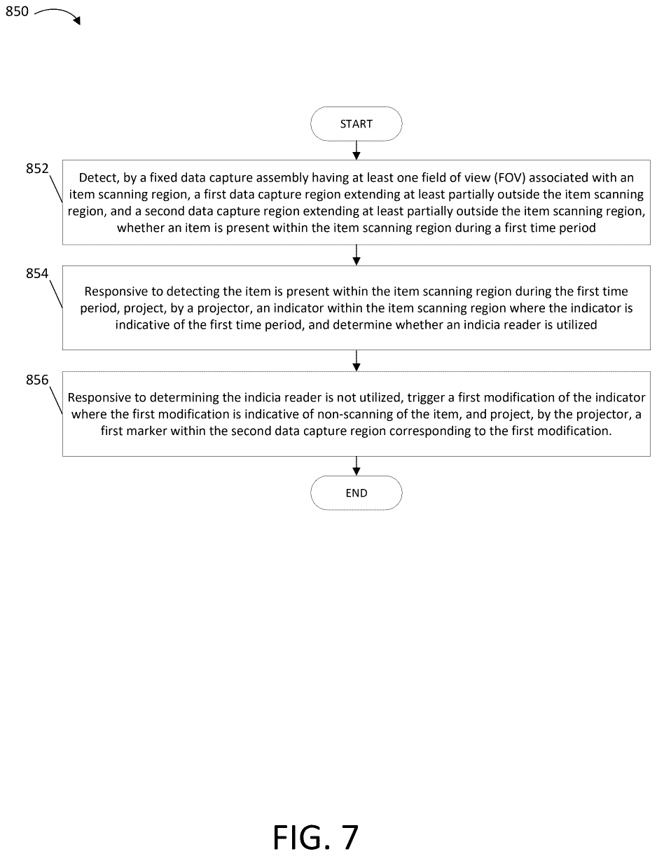

As shown in FIG. 7, the first data capture region 832 is a lead-in area comprising a lead-in shopping cart area having a shopping cart 840 positioned therein. The second FOV includes at least one of a partial or an entire opening 842 of the shopping cart 840 positioned in the lead-in shopping cart area and/or a partial or an entire bottom surface of the shopping cart 840 positioned in the lead-in shopping cart area.

Additionally, the second data capture region 834 is a lead-out area comprising one of a lead-out bagging area having a bag 844 positioned therein. The third FOV includes at least one of a partial or an entire opening of a bag 846 positioned in the lead-out bagging area. As described in further detail below, the projector 104 in conjunction with the imaging assembly 106 provide for guided indicia decoding via projected indicators and/or markers at a POS terminal to assist a user 836 during a self-checkout process to execute a transaction for the item 838.

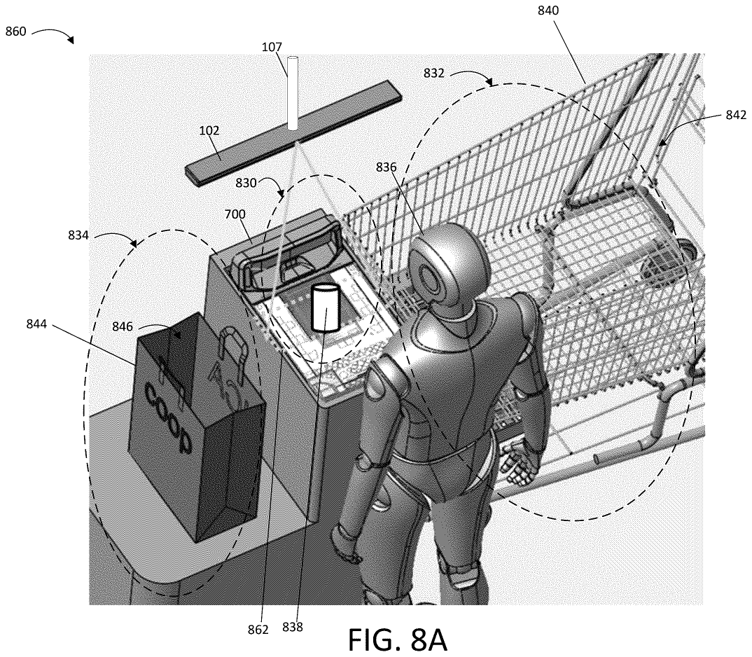

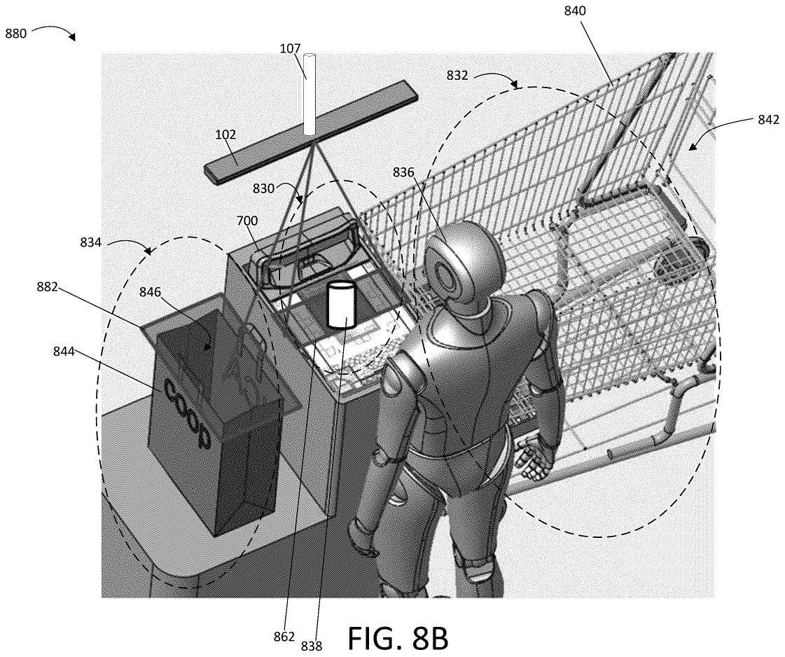

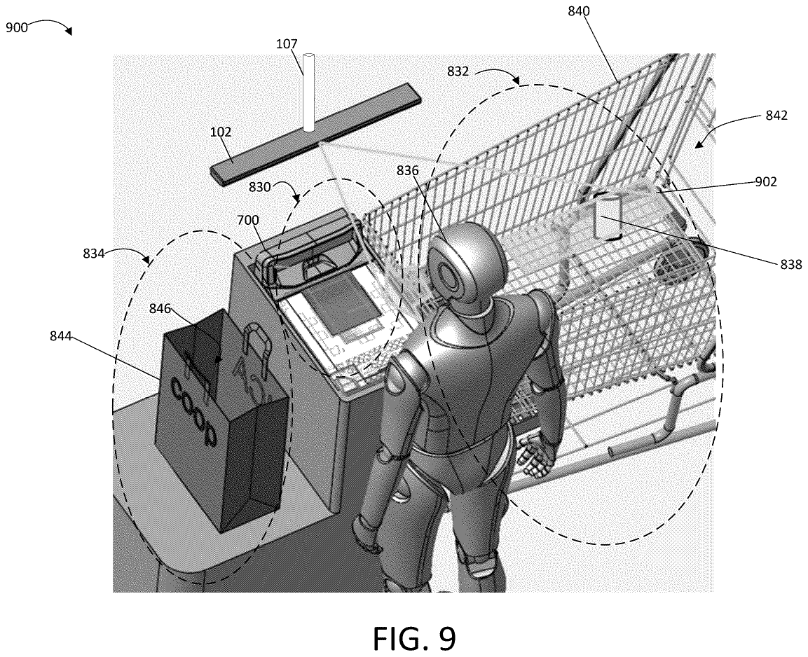

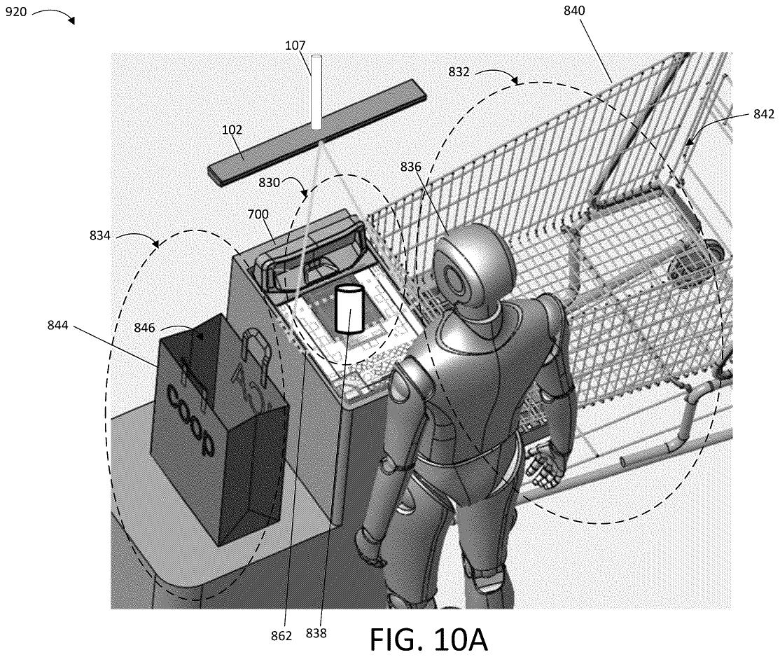

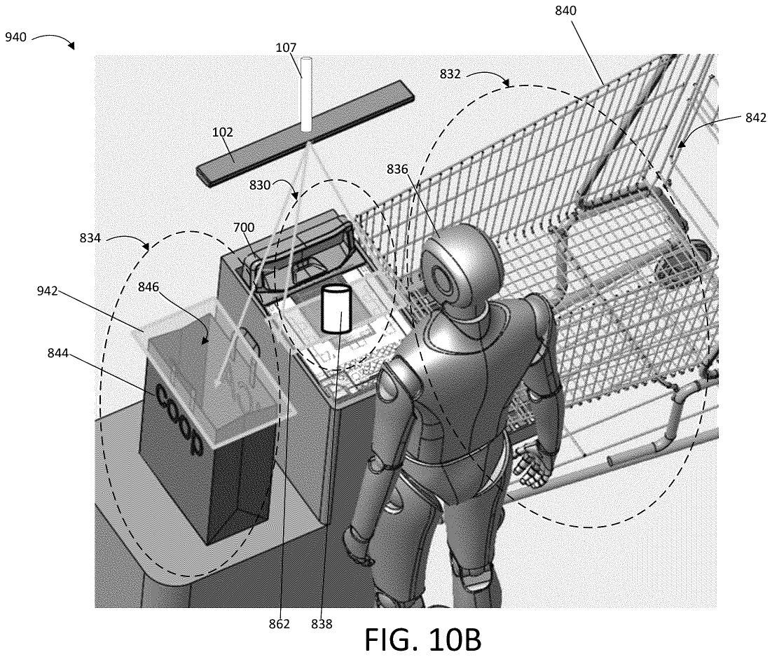

FIG. 7 is a flowchart illustrating processing steps 850 carried out by an embodiment of the present disclosure. The processing steps will be described in relation to FIG. 6 and/or the features of the projector 104 as shown in FIGS. 8A-B, 9, and 10A-B. For legibility of FIGS. 8A-B, 9, and 10A-B, the components of the fixed data capture assembly 102 and the indicia reader 700, and the respective features thereof (e.g., FsoV), as described above, and illustrated and labeled in relation to FIGS. 1, 3, 4, and 5A-B, are not illustrated and labeled individually.

Beginning in step 852, the system detects, by a fixed data capture assembly 102 having at least one FOV associated with an item scanning region 830, a first data capture region 832 extending at least partially outside the item scanning region 830, and a second data capture region 834 extending at least partially outside the item scanning region 830, whether an item 838 is present within the item scanning region 830 during a first time period.

In step 854, responsive to detecting the item 838 is present within the item scanning region 830 during the first time period, the system projects, by a projector 104, an indicator 862 within the item scanning region 830 where the indicator 862 is indicative of the first time period, and determines whether an indicia reader 700 is utilized. The first time period may be associated with a scanning session within the item scanning region 830 or a transaction session of the system. The indicator may be at least one of a rectangular reticle, a circular reticle, a bounding box, or an arrow indicative of a positioning and/or a motion of the item 838 within the item scanning region 830 to scan the item 838.

FIG. 8A is a diagram 860 illustrating step 804 of FIG. 7. As shown in FIG. 8A, responsive to detecting an item 838 is present within the item scanning region 830 during a first time period, the system projects, by a projector, an indicator 862 within the item scanning region 830. The indicator 862 may be indicative of the first time period (e.g., a scanning session within the item scanning region 830 or a transaction session of the system). As shown in FIG. 8A, the indicator 862 is a rectangular reticle positioned within the item scanning region 830 and comprises a dashed line (e.g., of a particular color), and the user 836 positions the item 838 within the rectangular reticle indicator 862. In this way, the indicator 862 guides the user 836 to position the item 838 and/or execute a motion (e.g., a swipe) of the item 838 within the item scanning region 830 to scan an identifier or indicium (e.g., a barcode) of the item 838. The indicator 862 may be at least one of a rectangular reticle, a circular reticle, a bounding box, an arrow or any suitable indicator indicative of a positioning and/or a motion of the item 838 within the item scanning 830 region to scan the item 838. As described in further detail below, the system determines whether an indicia reader 700 is utilized to scan and decode an identifier or indicium (e.g., a barcode) of the item 838.

Referring back to FIG. 7, in step 856, responsive to determining the indicia reader 700 is not utilized, the system triggers a first modification of the indicator 862 where the first modification is indicative of non-scanning of the item 838, and projects, by the projector, a first marker 882 within the second data capture region 834 corresponding to the first modification. The first modification comprises at least one of a change in color, shape, direction, projection frequency, or any suitable modification of the indicator 862. The first marker 882 may be at least one of a shape or text indicating to a user 836 not to position an item 838 within the second data capture region 834.

FIG. 8B is a diagram 880 illustrating step 806 of FIG. 7. As shown in FIG. 8B, responsive to determining the indicia reader 700 is not utilized, the system triggers a first modification of the indicator 862 where the first modification is indicative of non-scanning of the item 838, and projects, by the projector, a first marker 882 within the second data capture region 834 corresponding to the first modification. In this way, the first modification of the indicator 862 and the first marker 882 notify a user 836 of non-scanning of the item 838 and may prompt the user 836 to position the item 838 and/or execute a motion (e.g., a swipe) of the item 838 within the item scanning region 830 to re-scan an identifier or indicium (e.g., a barcode) of the item 838.

In an embodiment, the system may determine the indicia reader 700 is not utilized by determining the indicia reader 700 does not decode an indicium associated with the item 838. In this way, the system can determine an improper scanning event (e.g., a scan avoidance event or a missing or illegible indicium). In another embodiment, the system may determine the indicia reader 700 is not utilized by determining the indicia reader 700 decodes an indicium associated with the item 838 and the decoded indicium does not correspond to identification information of the item 838 detected by the fixed data capture assembly 102. In this way, the system can determine an improper scanning event (e.g., a ticket or barcode switching event). It should be understood that an improper scanning event need not be nefarious.

In an embodiment, responsive to determining the indicia reader 700 is not utilized, the system may generate an alert, and project, by the projector, the alert within the item scanning region 830 and/or display the alert on at least one of a display of the system or a display of a mobile device of a user (e.g., an associate or manager) associated with the system. In this way, the projected and/or displayed alert may provide further notice to a user 836 of non-scanning of the item 838 and may prompt the user 836 to position the item 838 and/or execute a motion (e.g., a swipe) of the item 838 within the item scanning region 830 to re-scan an identifier or indicium (e.g., a barcode) of the item 838. Additionally, the displayed alert may notify another user (e.g., an associate or manager) of non-scanning of the item 838 and facilitate prompt intervention to address the non-scanning of the item 838.

FIG. 9 is a diagram 900 illustrating processing steps carried out by an embodiment of the present disclosure. In an embodiment, the system may detect an item 838 is present within the first data capture region 832 and outside of the item scanning region 830. Responsive to determining the item 838 is not present within the item scanning region 830 during the first time period, the system may project, by the projector, a second marker 902 within the first data capture region 832. The first time period may be associated with a scanning session within the item scanning region 830 or a transaction session of the system. The second marker 902 may be indicative of the item 838 being present within the first data capture region and outside of the item scanning region during the first time period. For example, the second marker 902 may be indicative of an item 838 forgotten in a shopping cart 840 during a scanning session within the item scanning region 830 or a transaction session of the system. The second marker 902 may be at least one of a shape or text indicating to a user 836 to position an item 838 within the item scanning region 830 or a path from the first data capture region 832 to the item scanning region 830 for positioning the item 838 in the item scanning region 830. In an embodiment, the second marker 902 may follow along atop the item 838 and be modified based on scanning or non-scanning of the item 838.

As shown in FIG. 9, the second marker 902 is an arrow partially encompassing the item 838 and having a direction towards the item scanning region 830 from the first data capture region 832. In this way, the second marker 902 notifies a user 836 of an omitted scanning event (e.g., an item 838 proximate to a POS terminal that is not scanned) and may prompt the user 836 to position the item 838 and/or execute a motion (e.g., a swipe) of the item 838 within the item scanning region 830 to scan an identifier or indicium (e.g., a barcode) of the item 838.

FIGS. 10A and 10B are diagrams illustrating processing steps carried out by an embodiment of the present disclosure.

FIG. 10A is a diagram 920 illustrating step 804 of FIG. 7. As shown in FIG. 10A, responsive to detecting an item 838 is present within the item scanning region 830 during a first time period, the system projects, by a projector, an indicator 862 within the item scanning region 830. The indicator 862 may be indicative of the first time period (e.g., a scanning session within the item scanning region 830 or a transaction session of the system). As shown in FIG. 10A, the indicator 862 is a rectangular reticle positioned within the item scanning region 830 and comprises a dashed line (e.g., of a particular color), and the user 836 positions the item 838 within the rectangular reticle indicator 862. In this way, the indicator 862 guides the user 836 to position the item 838 and/or execute a motion (e.g., a swipe) of the item 838 within the item scanning region 830 to scan an identifier or indicium (e.g., a barcode) of the item 838. The indicator 862 may be at least one of a rectangular reticle, a circular reticle, a bounding box, an arrow or any suitable indicator indicative of a positioning and/or a motion of the item 838 within the item scanning 830 region to scan the item 838.

FIG. 10B is a diagram 940 illustrating processing steps carried out by an embodiment of the present disclosure. As shown in FIG. 10B, responsive to determining the indicia reader 700 is utilized, the system triggers a second modification of the indicator 862 where the second modification is indicative of scanning of the item 838, and projects, by the projector, a third marker 942 within the second data capture region 834 corresponding to the second modification. The second modification comprises at least one of a change in color, shape, direction, projection frequency, or any suitable modification of the indicator 862. The third marker 942 may be at least one of a shape or text indicating to a user 836 to position an item 838 within the second data capture region 834 or a path from the item scanning region 830 to the second data capture region 834 for positioning the item 838 in the second data capture region 834. In this way, the second modification of the indicator 862 and the third marker 942 notify a user 836 of scanning of the item 838 and may prompt the user 836 to position the item 838 within the second data capture region 834. In an embodiment, the system may determine the indicia reader 700 is utilized by determining the indicia reader 700 decodes an indicium associated with the item 838 and the decoded indicium corresponds to identification information of the item 838 detected by the fixed data capture assembly 102. In this way, the system can determine a proper scanning event.

As noted above, conventional checkout and self-checkout POS terminals suffer from a general lack of versatility because conventional checkout and self-checkout POS terminals cannot automatically and dynamically address exceptions during the checkout or self-checkout process. For example, these conventional checkout and self-checkout POS terminals cannot automatically and dynamically utilize computer vision for guided indicia decoding via projected indicators and/or markers at a POS terminal to assist a user during a checkout or self-checkout process and expedite and improve an experience of a user.

Overall, this lack of versatility causes conventional checkout and self-checkout POS terminals to provide underwhelming performance and reduce the accuracy, efficiency, and general timeliness of scanning and decoding an identifier or indicium of an item to identify the item (e.g., to execute a transaction such as a checkout or self-checkout process for the item).

Thus, as described above, the present disclosure mitigates, if not eliminates, these and other problems with conventional checkout and self-checkout POS terminals via systems, devices, and methods that can automatically and dynamically utilize computer vision for guided indicia decoding via projected indicators and/or markers at a POS terminal to assist a user during a checkout or self-checkout process and expedite and improve an experience of a user.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. A system, comprising:
a fixed data capture assembly having at least one field of view (FOV) associated with one or more of an item scanning region of an indicia reader, a first data capture region extending at least partially outside the item scanning region, and a second data capture region extending at least partially outside the item scanning region;
a projector configured to project light within the item scanning region and at least one of the first data capture region and the second data capture region;
a processor; and
a memory communicatively coupled to the processor, the memory storing instructions that, when executed by the processor, cause the system to:
determine whether an item is present within the item scanning region during a first time period;
responsive to determining the item is present within the item scanning region during the first time period;
project, by the projector, an indicator within the item scanning region, the indicator being indicative of the first time period, and
determine whether the indicia reader is utilized; and
responsive to determining the indicia reader is not utilized,
trigger a first modification of the indicator, the first modification being indicative of non-scanning of the item, and
project, by the projector, a first marker within the second data capture region corresponding to the first modification.

2. The system of claim 1, wherein the instructions, when executed by the processor, further cause the system to
detect the item is present within the first data capture region and outside of the item scanning region; and
responsive to determining the item is not present within the item scanning region during the first time period,
project, by the projector, a second marker within the first data capture region, the second marker being indicative of the item being present within the first data capture region and outside of the item scanning region during the first time period,
wherein the second marker is at least one of a shape or text indicating to position the item within the item scanning region or a path from the first data capture region to the item scanning region for positioning the item in the item scanning region.

3. The system of claim 1, wherein the instructions, when executed by the processor, cause the system to determine the indicia reader is not utilized by:
determining the indicia reader does not decode an indicium associated with the item; or
determining the indicia reader decodes the indicium associated with the item and the decoded indicium does not correspond to identification information of the item detected by the fixed data capture assembly.

4. The system of claim 1, wherein the instructions, when executed by the processor, further cause the system to:
responsive to determining the indicia reader is utilized, trigger a second modification of the indicator, the second modification being indicative of scanning of the item; and
project, by the projector, a third marker within the second data capture region corresponding to the second modification, wherein
the second modification comprises at least one of a change in color, shape, direction, or projection frequency of the indicator, and
the third marker is at least one of a shape or text indicating to position the item within the second data capture region or a path from the item scanning region to the second data capture region for positioning the item in the second data capture region.

5. The system of claim 4, wherein the instructions, when executed by the processor, cause the system to determine the indicia reader is utilized by:
determining the indicia reader decodes an indicium associated with the item and the decoded indicium corresponds to identification information of the item detected by the fixed data capture assembly.

6. The system of claim 1, wherein the fixed data capture assembly has:
a first FOV corresponding to one of a downwardly directed looking vision camera assembly, an infrared (IR) sensor assembly, or a lidar sensor assembly comprising at least one imager configured to scan an indicium associated with the item within the item scanning region;
a second FOV corresponding to a downwardly directed looking vision camera assembly configured to detect the item within the first data capture region; and
a third FOV corresponding to a downwardly directed looking vision camera assembly configured to detect the item within the second data capture region.

7. The system of claim 6, wherein
the first data capture region is a lead-in area comprising one of a lead-in shopping cart area, a lead-in basket area, a lead-in flatbed cart area, or a lead-in countertop area;
the second FOV includes at least one of a partial or an entire opening of a shopping cart positioned in the lead-in shopping cart area and/or a partial or an entire bottom surface of the shopping cart positioned in the lead-in shopping cart area, a partial or an entire opening of a basket positioned in the lead-in basket area, a partial or an entire top surface of a flatbed cart positioned in the lead-in flatbed cart area, or a partial or an entire top surface of a countertop positioned in the lead-in countertop area;
the second data capture region is a lead-out area comprising one of a lead-out shopping cart area, a lead-out basket area, a lead-out flatbed cart area, or a lead-out countertop area; and
the third FOV includes at least one of a partial or an entire opening of a shopping cart positioned in the lead-out shopping cart area and/or a partial or an entire bottom surface of the shopping cart positioned in the lead-out shopping cart area, a partial or an entire opening of a basket positioned in the lead-out basket area, a partial or an entire top surface of a flatbed cart positioned in the lead-out flatbed cart area, or a partial or an entire top surface of a countertop positioned in the lead-out countertop area.

8. The system of claim 1, wherein
the projector is one of a laser projector, a light emitting diode (LED) projector, an array of fixed aiming patterns, or a digital light processing (DLP) projector;
the projector is one of ceiling mounted, stalk mounted or positioned within one of the fixed data capture assembly or the indicia reader; and
the projector is communicatively coupled to the indicia reader.

9. The system of claim 1, wherein
the first time period is associated with a scanning session within the item scanning region or a transaction session of the system; and
the indicia reader is a scanner.

10. The system of claim 1, wherein
the indicator is at least one of a rectangular reticle, a circular reticle, a bounding box, or an arrow indicative of a positioning and/or a motion of the item within the item scanning region to scan the item;
the first modification comprises at least one of a change in color, shape, direction, or projection frequency of the indicator, and
the first marker is at least one of a shape or text indicating not to position the item within the second data capture region.

11. The system of claim 1, wherein the instructions, when executed by the processor, further cause the system to:
responsive to determining the indicia reader is not utilized,
generate an alert, and
project, by the projector, the alert within the item scanning region, or
display the alert on at least one of a display of the system or a display of a mobile device of a user associated with the system.

12. A fixed data capture assembly, comprising:
at least one field of view (FOV) associated with one or more of an item scanning region of an indicia reader, a first data capture region extending at least partially outside the item scanning region, and a second data capture region extending at least partially outside the item scanning region;
a projector configured to project light within the item scanning region and at least one of the first data capture region and the second data capture region;
a processor; and
a memory communicatively coupled to the processor, the memory storing instructions that, when executed by the processor, cause the fixed data capture assembly to:
determine whether an item is present within the item scanning region during a first time period;
responsive to determining the item is present within the item scanning region during the first time period;
project, by the projector, an indicator within the item scanning region, the indicator being indicative of the first time period; and
determine whether the indicia reader is utilized; and
responsive to determining the indicia reader is not utilized,
trigger a first modification of the indicator, the first modification being indicative of non-scanning of the item, and
project, by the projector, a first marker within the second data capture region corresponding to the first modification.

13. The fixed data capture assembly of claim 12, wherein the instructions, when executed by the processor, further cause the fixed data capture assembly to:
detect the item is present within the first data capture region and outside of the item scanning region; and
responsive to determining the item is not present within the item scanning region during the first time period,
project, by the projector, a second marker within the first data capture region, the second marker being indicative of the item being present within the first data capture region and outside of the item scanning region during the first time period,
wherein the second marker is at least one of a shape or text indicating to position the item within the item scanning region or a path from the first data capture region to the item scanning region for positioning the item in the item scanning region.

14. The fixed data capture assembly of claim 12, wherein the instructions, when executed by the processor, cause the fixed data capture assembly to determine the indicia reader is not utilized by:
determining the indicia reader does not decode an indicium associated with the item; or
determining the indicia reader decodes the indicium associated with the item and the decoded indicium does not correspond to identification information of the item detected by the fixed data capture assembly.

15. The fixed data capture assembly of claim 12, wherein the instructions, when executed by the processor, further cause the fixed data capture assembly to:
responsive to determining the indicia reader is utilized, trigger a second modification of the indicator, the second modification being indicative of scanning of the item; and
project, by the projector, a third marker within the second data capture region corresponding to the second modification, wherein
the second modification comprises at least one of a change in color, shape, direction, or projection frequency of the indicator, and
the third marker is at least one of a shape or text indicating to position the item within the second data capture region or a path from the item scanning region to the second data capture region for positioning the item in the second data capture region.

16. The fixed data capture assembly of claim 15, wherein the instructions, when executed by the processor, cause the fixed data capture assembly to determine the indicia reader is utilized by:
determining the indicia reader decodes an indicium associated with the item and the decoded indicium corresponds to identification information of the item detected by the fixed data capture assembly.

17. The fixed data capture assembly of claim 12, wherein the fixed data capture assembly has:
a first FOV corresponding to one of a downwardly directed looking vision camera assembly, an infrared (IR) sensor assembly, or a lidar sensor assembly comprising at least one imager configured to scan an indicium associated with the item within the item scanning region;
a second FOV corresponding to a downwardly directed looking vision camera assembly configured to detect the item within the first data capture region; and
a third FOV corresponding to a downwardly directed looking vision camera assembly configured to detect the item within the second data capture region.

18. The fixed data capture assembly of claim 17, wherein
the first data capture region is a lead-in area comprising one of a lead-in shopping cart area, a lead-in basket area, a lead-in flatbed cart area, or a lead-in countertop area;
the second FOV includes at least one of a partial or an entire opening of a shopping cart positioned in the lead-in shopping cart area and/or a partial or an entire bottom surface of the shopping cart positioned in the lead-in shopping cart area, a partial or an entire opening of a basket positioned in the lead-in basket area, a partial or an entire top surface of a flatbed cart positioned in the lead-in flatbed cart area, or a partial or an entire top surface of a countertop positioned in the lead-in countertop area;
the second data capture region is a lead-out area comprising one of a lead-out shopping cart area, a lead-out basket area, a lead-out flatbed cart area, or a lead-out countertop area; and
the third FOV includes at least one of a partial or an entire opening of a shopping cart positioned in the lead-out shopping cart area and/or a partial or an entire bottom surface of the shopping cart positioned in the lead-out shopping cart area, a partial or an entire opening of a basket positioned in the lead-out basket area, a partial or an entire top surface of a flatbed cart positioned in the lead-out flatbed cart area, or a partial or an entire top surface of a countertop positioned in the lead-out countertop area.

19. The fixed data capture assembly of claim 12, wherein
the projector is one of a laser projector, a light emitting diode (LED) projector, an array of fixed aiming patterns, or a digital light processing (DLP) projector;
the projector is one of ceiling mounted, stalk mounted or positioned within one of the fixed data capture assembly or the indicia reader; and
the projector is communicatively coupled to the indicia reader.

20. The fixed data capture assembly of claim 12, wherein
the indicator is at least one of a rectangular reticle, a circular reticle, a bounding box, or an arrow indicative of a positioning and/or motion of the item within the item scanning region to scan the item;
the first modification comprises at least one of a change in color, shape, direction, or projection frequency of the indicator, and
the first marker is at least one of a shape or text indicating not to position the item within the second data capture region.

21. The fixed data capture assembly of claim 12, wherein the instructions, when executed by the processor, further cause the fixed data capture assembly to:
responsive to determining the indicia reader is not utilized,
generate an alert, and
project, by the projector, the alert within the item scanning region, or
display the alert on at least one of a display of the fixed data capture assembly or a display of a mobile device of a user associated with the fixed data capture assembly.

22. A method, comprising:
detecting, by a fixed data capture assembly having at least one field of view (FOV) associated with an item scanning region, a first data capture region extending at least partially outside the item scanning region, and a second data capture region extending at least partially outside the item scanning region, whether an item is present within the item scanning region during a first time period;
responsive to detecting the item is present within the item scanning region during the first time period;
projecting, by a projector, an indicator within the item scanning region, the indicator being indicative of the first time period, and
determining whether an indicia reader is utilized; and
responsive to determining the indicia reader is not utilized,
triggering a first modification of the indicator, the first modification being indicative of non-scanning of the item, and
projecting, by the projector, a first marker within the second data capture region corresponding to the first modification.

23. The method of claim 22, further comprising:
detecting, by the fixed data capture assembly, the item is present within the first data capture region and outside of the item scanning region; and
responsive to determining the item is not present within the item scanning region during the first time period;
projecting, by the projector, a second marker within the first data capture region, the second marker being indicative of the item being present within the first data capture region and outside of the item scanning region during the first time period,
wherein the second marker is at least one of a shape or text indicating to position the item within the item scanning region or a path from the first data capture region to the item scanning region for positioning the item in the item scanning region.

24. The method of claim 22, wherein determining the indicia reader is not utilized comprises:
determining the indicia reader does not decode an indicium associated with the item; or
determining the indicia reader decodes the indicium associated with the item and the decoded indicium does not correspond to identification information of the item detected by the fixed data capture assembly.

25. The method of claim 22, further comprising:
responsive to determining the indicia reader is utilized, triggering a second modification of the indicator, the second modification being indicative of scanning of the item; and
projecting, by the projector, a third marker within the second data capture region corresponding to the second modification, wherein
the second modification comprises at least one of a change in color, shape, direction, or projection frequency of the indicator, and
the third marker is at least one of a shape or text indicating to position the item within the second data capture region or a path from the item scanning region to the second data capture region for positioning the item in the second data capture region.

26. The method of claim 25, wherein determining the indicia reader is utilized comprises:
determining the indicia reader decodes an indicium associated with the item and the decoded indicium corresponds to identification information of the item detected by the fixed data capture assembly.

27. The method of claim 22, wherein the fixed data capture assembly has:
a first FOV corresponding to one of a downwardly directed looking vision camera assembly, an infrared (IR) sensor assembly, or a lidar sensor assembly comprising at least one imager configured to scan an indicium associated with the item within the item scanning region;
a second FOV corresponding to a downwardly directed looking vision camera assembly configured to detect the item within the first data capture region; and
a third FOV corresponding to a downwardly directed looking vision camera assembly configured to detect the item within the second data capture region.

28. The method of claim 27, wherein
the first data capture region is a lead-in area comprising one of a lead-in shopping cart area, a lead-in basket area, a lead-in flatbed cart area, or a lead-in countertop area;
the second FOV includes at least one of a partial or an entire opening of a shopping cart positioned in the lead-in shopping cart area and/or a partial or an entire bottom surface of the shopping cart positioned in the lead-in shopping cart area, a partial or an entire opening of a basket positioned in the lead-in basket area, a partial or an entire top surface of a flatbed cart positioned in the lead-in flatbed cart area, or a partial or an entire top surface of a countertop positioned in the lead-in countertop area;
the second data capture region is a lead-out area comprising one of a lead-out shopping cart area, a lead-out basket area, a lead-out flatbed cart area, or a lead-out countertop area; and
the third FOV includes at least one of a partial or an entire opening of a shopping cart positioned in the lead-out shopping cart area and/or a partial or an entire bottom surface of the shopping cart positioned in the lead-out shopping cart area, a partial or an entire opening of a basket positioned in the lead-out basket area, a partial or an entire top surface of a flatbed cart positioned in the lead-out flatbed cart area, or a partial or an entire top surface of a countertop positioned in the lead-out countertop area.

29. The method of claim 22, wherein
the projector is one of a laser projector, a light emitting diode (LED) projector, an array of fixed aiming patterns, or a digital light processing (DLP) projector;
the projector is one of ceiling mounted, stalk mounted or positioned within one of the fixed data capture assembly or the indicia reader; and
the projector is communicatively coupled to the indicia reader.

30. The method of claim 22, wherein
the indicator is at least one of a rectangular reticle, a circular reticle, a bounding box, or an arrow indicative of a positioning and/or motion of the item within the item scanning region to scan the item;
the first modification comprises at least one of a change in color, shape, direction, or projection frequency of the indicator, and
the first marker is at least one of a shape or text indicating not to position the item within the second data capture region.

31. The method of claim 22, further comprising:
responsive to determining the indicia reader is not utilized,
generating an alert, and
projecting, by the projector, the alert within the item scanning region, or
displaying the alert on at least one of a display of the fixed data capture assembly or a display of a mobile device of a user associated with the fixed data capture assembly.
